(19) United States
(12) Patent Application Publication
(10) Pub. No.: US 2021/0355706 A1
(43) Pub. Date: Nov. 18, 2021

(54) COPPER ALLOYS AND METHODS FOR MAKING THE SAME

(71) Applicant: THE TEXAS A&M UNIVERSITY SYSTEM, College Station, TX (US)

(72) Inventors: Benton ALLEN, College Station, TX (US); Emily HUNT, College Station, TX (US); Trenton KELLY, College Station, TX (US); Paige DODGE, College Station, TX (US)

(21) Appl. No.: 17/318,501

(22) Filed: May 12, 2021

Related U.S. Application Data
(60) Provisional application No. 63/077,791, filed on Sep. 14, 2020.
(60) Provisional application No. 63/023,418, filed on May 12, 2020.

(51) Int. Cl. E05B 1/00; C22C 9/06; B32B 15/20

(52) U.S. Cl. CPC E05B 1/00; C22C 9/06; B32B 15/20; C22C 2202/00; B32B 2307/7145; B32B 2419/00; B32B 2311/12

(57) ABSTRACT

A multilayer patch includes a copper alloy layer and an adhesive layer. The multilayer patch is capable of wrapping around cylindrical, flat, and/or abstract surfaces. The multilayer patch provides an antimicrobial property to the surface to which it is coupled.

### CROSS-REFERENCE TO RELATED APPLICATIONS

This application claims priority under 35 U.S.C. § 119(e) to U.S. Provisional Application No. 63/023,418, filed on May 12, 2020, and 63/077,791, filed on Sep. 14, 2020, the entire disclosure of each is incorporated herein by reference.

### BACKGROUND

Every day, people come into contact with a variety of touch surfaces. From subway grab rails to doorknobs, keyboards, and telephones, touch is a fundamental part of our day-to-day lives. Unfortunately, these same objects we touch are also touched by many others. Frequent contact can leave behind infectious bacteria on these surfaces, putting the next user at risk. Harmful organisms can survive on surfaces like stainless steel and plastic for days and even months, still posing a threat to human health. And once you know that 80% of infectious diseases are transferred by touch, the need to clean surfaces becomes evident. However, cleaning the surfaces is only part of the solution. Even strict hand washing and disinfection protocols recommended by the U.S. Centers for Disease Control and Prevention (CDC) are not enough to prevent infections in hospitals. In the past, silver-containing coatings have been tried, and found inadequate as they only protect the product itself and not the person using it.

There are several types of antimicrobial agents that are currently available which include chemical disinfectants. However, these chemicals are often harmful to both the environment and the person coming into contact with them. These agents are typically short-term solutions and need to be applied repeatedly to remain effective. In scientific research published in the wake of the recent worldwide pandemic, copper has been show to effectively fight the new coronavirus. Indeed, the virus lasted on copper for just a few hours, compared with days on stainless steel and plastic. What is needed is a touch surface that continually kills pathogens that cause infections and illness. Thus, there is a need for a technology that protects high-touch and shared surfaces from harmful pathogens.

### SUMMARY

According to one aspect of the present disclosure, a door handle comprises a body configured to receive a force from a user to open a door, and a multilayer patch extending around at least a portion of the body. The multilayer patch is arranged to be contacted by the user when the user applies a force to the body of the door handle. In illustrative embodiments, the multilayer patch comprises an adhesive layer that is arranged to contact the body and a copper alloy layer that is arranged to be contacted by the user.

According to another aspect of the present disclosure, a multilayer patch comprises a backing layer, an adhesive layer in direct contact with the backing layer, and a copper alloy layer located spaced apart from the backing layer and arranged to locate the adhesive layer therebetween. In illustrative embodiments, the copper alloy layer comprises copper, nickel, and at least one other metal.

According to another aspect of the present disclosure, a method comprises peeling away a backing layer to form a multilayer patch, the multilayer patch comprising an adhesive layer and a copper alloy layer; and coupling the multilayer patch to a surface so that the adhesive layer is located between the copper alloy layer and the surface. In illustrative embodiments, the multilayer patch is less than about 10 mils thick.

Additional embodiments, features, and advantages of the disclosure will be apparent from the following detailed description and through practice of the disclosure. The process and compounds of the present disclosure can be described as embodiments in any of the following enumerated clauses. It will be understood that any of the embodiments described herein can be used in connection with any other embodiments described herein to the extent that the embodiments do not contradict one another.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

FIG. 1 shows Staph aureus viability on a copper alloy compared to stainless steel, reproduced from the Copper Development Association.

FIG. 2 shows MRSA viability on a copper alloy compared to stainless steel, reproduced from the Copper Development Association.

FIG. 3 shows E. coli viability on a copper alloy compared to stainless steel and plastic, reproduced from the Copper Development Association.

FIG. 4 shows the microbe growth of a push bar without the multilayer patch compared to a push bar that had the multilayer patch.

FIG. 5 shows the microbe growth of a door handle without the multilayer patch compared to a door handle that had the multilayer patch.

FIG. 6 shows the microbe growth of an elevator button without the multilayer patch compared to an elevator button that had the multilayer patch.

FIG. 7 shows the microbe growth of an exit push bar without the multilayer patch compared to an exit push bar that had the multilayer patch.

FIG. 8 shows the microbe growth of another exit push bar without the multilayer patch compared to an exit push bar that had the multilayer patch.

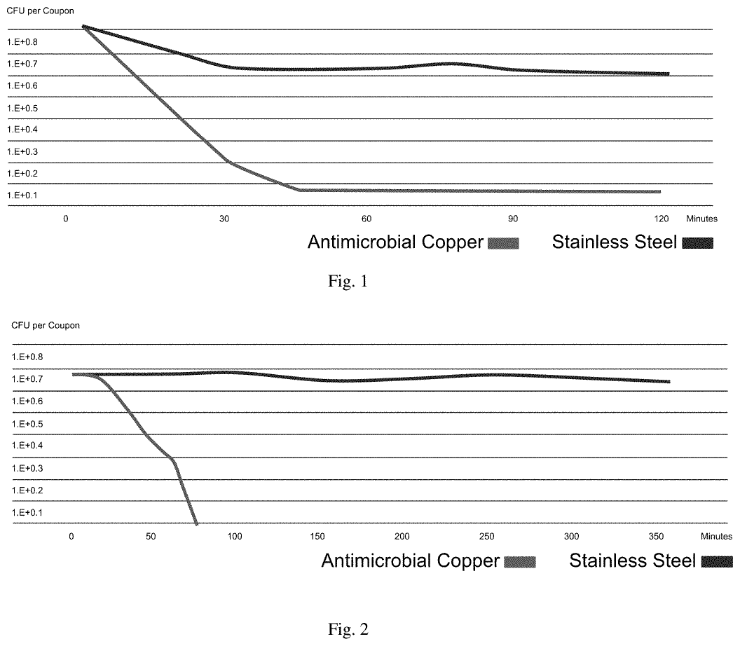

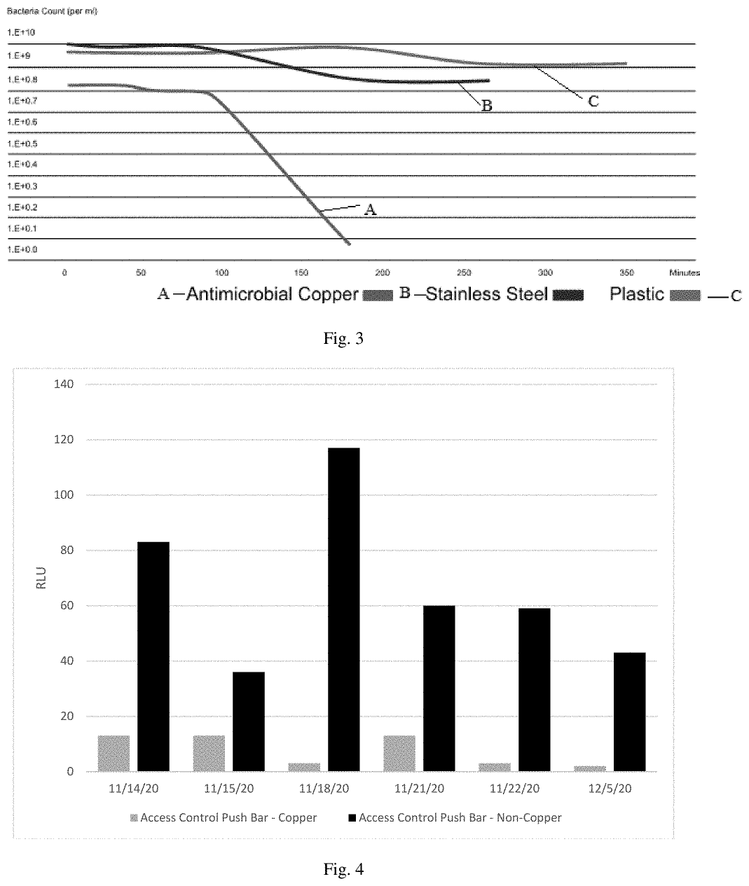

### DETAILED DESCRIPTION

Many copper products are essentially pure copper with little to no alloying metals. Pure copper tarnishes (turns green or brown) almost instantaneously. To prevent this rapid surface degradation, most copper products have a very thin clear coating to preserve the base copper material. However, while that clear coating does not interfere with the electrical conductivity of the copper, it prevents the surface from killing microorganisms because copper ions cannot kill microorganisms when they are coated. Pure copper materials are not designed (or approved by the EPA) to provide protection from harmful microorganisms.

The multilayer patch described herein comprises a copper alloy layer that provides antimicrobial properties to the surface to which it is attached. The multilayer patches described herein also possess sufficient flexibility so that the multilayer patch can conform to the surface to which it is attached. For example, a multilayer patch described herein has sufficient flexibility to wrap around a cylinder or contoured surface and have at least about 90%, at least about 95% or at least about 99% of the multilayer patch in contact with the surface. As another example, the multilayer patch described herein can be bent or folded and then return to the original shape without deforming. Thicker or less flexible copper-based materials may crease when bent or folded in such a manner.

The multilayer patch may be adapted for use at a location selected from the group consisting of educational facilities, healthcare facilities, financial institutions, commercial real estate buildings and facilities, entertainment facilities, elevators, the hospitality industry, convenience stores, grocery stores, churches, restaurants, gym facilities, and fitness facilities. In some embodiments, the multilayer patch is adapted for use as a consumer product, as a retail product, as a surface patch, as a crash bar patch, as a lever handle patch, as a mobile device patch, as a pneumatic tube carrier patch, as a car protection patch, or as a push plate patch.

A multilayer patch according to the present disclosure includes a copper alloy layer and an adhesive layer. The adhesive layer is arranged to extend between and interconnect the copper alloy layer and a release layer or, when the patch has been applied, a surface. For example, a user may peel the copper alloy layer and adhesive away from a release layer or a backing layer so that it can be installed on a surface. Illustrative surfaces include those that may be contacted by a person. For example, surfaces include building door handles, push plates, car door handles, and phone cases as well as specialized applications such as pneumatic tube carriers and financial equipment hardware. Illustratively, the surface may be contoured. In some embodiments, the surface is not a flat surface.

In an example, a door handle includes a body and a patch coupled to the body so that the adhesive layer is located between the copper alloy layer and a surface of the body. The body may be a door handle or knob, a push plate, or a pull bar. In another example, a cart handle includes a body and a patch coupled to the body so that the adhesive layer is located between the copper alloy layer and a surface of the body. In these examples, the patch is arranged to directly contact a user.

The multilayer patch may have a particular thickness. In some embodiments, the multilayer patch is about 8 mils or about 10 mils thick. In some embodiments, the multilayer patch is at least 2 mils or at least 3 mils thick. In some embodiments, the multilayer patch is less than about 20 mils or less than about 16 mils thick. In some embodiments, the multilayer patch is about 1 mil to about 20 mils, about 1 mil to about 18 mils, about 2 mils to about 18 mils, about 2 mils to about 16 mils, about 2 mils to about 14 mils, about 2 mils to about 12 mils, about 2 mils to about 10 mils, or about 2 mils to about 8 mils. The thickness of the multilayer patch may be adjusted depending on the use. For example, thinner multilayer patches may advantageous to increase flexibility whereas thicker patches may provide improved wear resistance.

Illustratively, the multilayer patch is flexible so that it can be coupled to a surface by a user by using only hand pressure. In some embodiments, the multilayer patch can be adhered fully to contoured surfaces without tooling. In illustrative embodiments, the multilayer patch can be contoured to flat or curved surfaces without dissolving the bond between or separating the copper alloy later and the adhesive layer. In some embodiments, the multilayer patch is removable from the surface by heating the patch with a heat gun or other suitable device without damaging the surface.

The multilayer patch has a yield strength as measured by ASTM C774-88(2016). In some embodiments, the yield strength of the multilayer patch is less than about 80, less than about 60, or less than about 50 ksi. In some embodiments, the yield strength is about 15 ksi to about 80 ksi, about 15 ksi to about 60 ksi, about 15 ksi to about 50 ksi, about 20 ksi to about 50 ksi, about 25 ksi to about 45 ksi, or about 30 ksi to about 40 ksi.

The multilayer patch has a modulus of elasticity as measured by ASTM E111-17. In some embodiments, the modulus of elasticity of the multilayer patch is less than about 50,000, less than about 40,000, or less than about 30,000 ksi. In some embodiments, the modulus of elasticity is about 5,000 ksi to about 50,000 ksi, about 5,000 ksi to about 40,000 ksi, about 5,000 ksi to about 30,000 ksi, about 10,000 ksi to about 30,000 ksi, about 15,000 ksi to about 30,000 ksi, about 15,000 to about 25,000 ksi, or about 15,000 ksi to about 20,000 ksi.

The multilayer patch has a modulus of rigidity as measured by ASTM E143-20. In some embodiments, the modulus of rigidity of the multilayer patch is less than about 10,000, less than about 9,000, or less than about 8,000 ksi. In some embodiments, the modulus of rigidity is about 4,000 ksi to about 10,000 ksi, about 4,000 ksi to about 9,000 ksi, about 4,000 ksi to about 8,000 ksi, about 5,000 ksi to about 8,000 ksi, about 5,500 ksi to about 8,000 ksi, about 5,500 ksi to about 7,500, or about 5,800 ksi to about 7,200 ksi.

The copper alloy layer is arranged to be contacted by a user when the patch is coupled to a surface. The copper alloy layer may be about 2 mils, about 3 mils, about 4 mils, about 5 mils, about 6 mils, about 7 mils, about 8 mils, about 9 mils, about 10 mils, about 11 mils, about 12 mils, about 13 mils, about 14 mils, about 15 mils, or about 16 mils thick. In some embodiments, the copper alloy layer is about 2 mils to about 16 mils, about 2 mils to about 14 mils, about 3 mils about 14 mils, about 3 mils to about 12 mils, about 3 mils to about 10 mils, or about 3 mils to about 9 mils thick.

The copper alloy layer comprises a copper alloy. Illustratively, the copper alloy may be an EPA-registered antimicrobial copper alloy. In some embodiments, the copper alloy comprises at least about 70%, at least about 80%, at least about 90%, at least about 95%, or at least about 99% by weight copper. In some embodiments, the copper alloy comprises between about 70% to about 99% copper, between about 80% to about 99% copper, between about 85% to about 99% copper, between about 85% to about 95% copper, or between about 90% to about 95% copper by weight.

In some embodiments, the copper alloy comprises at least one, at least two, or at least three other metals. In some embodiments, the copper alloy comprises copper and one additional metal, copper and two additional metals, copper and three additional metals, or copper and four additional metals. Additional metals include those known in the art for copper alloys. Illustratively, the additional metals include iron, chromium zinc, nickel, cobalt, and manganese.

In illustrative embodiments, the at least one metal is present at a concentration, or a combined concentration, of less than about 30%, less than about 20%, less than about 10%, less than about 5%, or less than about 1% by weight. In some embodiments, the at least one metal is present at a concentration, or a combined concentration, of between about 1% to about 30%, between about 1% to about 20%, between about 1% to about 15%, between about 5% to about 15%, or between about 5% to about 10%. The ranges described herein apply individually to the metals iron, chromium zinc, nickel, cobalt, and manganese as well as the combinations thereof. In illustrative embodiments, the copper alloy comprises about 85% to about 99% copper, up to about 15% nickel, and up to about 5% iron.

The patch includes an adhesive layer to secure the copper alloy layer to the substrate surface. In illustrative embodiments, the adhesive is a self-adhesive. The adhesive layer comprises an adhesive, for example 3M™ High Performance Acrylic Adhesive 200MP. In some embodiments, the adhesive performs well after exposure to humidity and hot/cold cycles. In some embodiments, the adhesive has up to 400° F. short-term heat resistance. In some embodiments, the adhesive is resistant to solvents. In some embodiments, the adhesive has sufficient shear strength to resist slippage and edge lifting. In some embodiments, when the multilayer patch is coupled to a surface, the multilayer patch can be removed by heating the multilayer patch.

The adhesive layer has a thickness as measured between the copper alloy layer and the surface or release layer to which the adhesive is touching. In some embodiments, the adhesive layer is about 2 mils to about 16 mils, about 2 mils to about 12 mils, about 2 mils to about 10 mils, about 4 mils to about 10 mils, or about 4 mils to about 8 mils thick.

Described herein is a process/method and a multilayer patch that may be applied to surfaces and help protect against the buildup or transfer of bacteria. The multilayer patch may include copper or copper alloy containing a minimum of 70% copper. The product may include an antimicrobial copper identified by the United States Environmental Protection Agency (EPA) as an antimicrobial. In some embodiments, the copper alloy surface should effectively kill bacteria within about two hours of exposure to the bacteria. The multilayer patch is self-adhesive to the touch surface. The multilayer patch is developed for educational facilities, healthcare facilities, financial institutions, commercial real estate buildings and facilities, entertainment facilities, elevators, the hospitality industry, convenience stores, grocery stores, churches, restaurants, gym and fitness facilities, consumer products, and retail products.

The antimicrobial copper surface (i.e., the copper alloy layer) can be made from a minimum of 70% copper alloy foil (approved by the EPA) and includes a self-adhesive backing for application. This disclosure also includes the process/method for manufacturing a product according to the principles of the disclosure. The method includes: providing a material including EPA registered antimicrobial copper; forming a multilayer patch from the provided material using a forming device; optionally applying an adhesive to a surface on a side (e.g., bottom side) of the copper alloy layer; optionally applying a potential protective coating layer to the adhesive layer; optionally applying an EPA registered copper alloy coating to an adhesive coated flexible membrane, and forming the material into a finished product. The applying of adhesive may include applying the adhesive such as, e.g., the material is unrolled from a reel, or further downstream as the material travels to, e.g., a punch press. The step of applying the adhesive may be done after the finished product is formed. This application of the adhesive may be done to a freestanding item as well. The method may further include applying a removable protective coating to a contact surface of the product, which may be removed by the consumer to expose the antimicrobial properties of the product surface.

The alloys described herein may be used in antimicrobial patches/stickers to protect common surfaces such as building door handles, push plates, car door handles, and phone cases as well as specialized applications such as pneumatic tube carriers and financial equipment hardware. Supplementary devices are also being developed to provide a suitable interface between the copper stickers and the device to be protected: i.e., a plastic sleeve with inner surface characteristics designed to cover a commercial cooler door or grocery/produce cart handle and outer surface designed to readily accept a copper sticker.

The outer surface of the multilayer patch may various surface finishes for increased aesthetic appeal or functionality. In some embodiments, the patch is treated by “stamping” patterns into the material (dimples, for instance, to hide scratches that occur after installation), lasering designs into the material, or changing the way the copper is processed at the mill (think brushed vs polished vs matte finish). In some embodiments, the multilayer patch includes an ink layer covering at least some of the copper alloy surface so that a portion of the copper alloy is located between the ink layer and the adhesive layer.

To use the multilayer patch described herein on complex geometries, a mating device that act as an intermediary between the target surface and the multilayer patch can be used. The mating device may comprise a polymer or blend of polymers. The mating device may be designed with an interior surface that contours to the target surface while providing an exterior surface that is optimized for application of a multilayer patch. In some embodiments, the mating device is used for a mass transit system handrail. The handrail is curved in a manner that prevents easy application of the multilayer patch without forming creases. Hence, the mating device has an interior surface that is contoured to the handrail and an exterior surface that forms a cylinder. This allows a patch product to be easily applied without any creases or folds. This methodology also allows for quick application in the field, easy maintenance and replacement, and creates a final product with no visible seams—making it incredibly resistant to vandalism. Similar mating devices may be useful for high-touch surfaces with complex geometry such as grocery store cooler door handles, grocery cart handles, stadium seat armrests, and ride-sharing applications such as scooter handles and seat belt covers. This same mating device methodology may also provide easy-to-remove products for commercial buildings and medical. These mating devices may also incorporate locking retainer rings on the top and bottom to securely affix the kit to the target surface and prevent unauthorized removal.

In some embodiments, the multilayer patch described herein is durable, self-sanitizing metal stickers that are applied to high-touch surfaces in medical facilities to kill surface-borne bacteria. Based on the testing conducted by the US EPA, the multilayer patch described herein has been shown, when cleaned regularly, to kill greater than 99.9% of the following bacteria within 2 hours of exposure: MRSA, VRE, Staphylococcus aureus, Enterobacter aerogenes, Pseudomonas aeruginosa, and E. coli O157:H7. The multilayer patch comprises a copper alloy that was registered by the EPA. By providing antimicrobial copper as an adhesive backed patch, the patches described herein allow medical facilities to retrofit existing bedrails, tray tables, IV poles, call buttons, door handles, and other high-touch surfaces with self-sanitizing antimicrobial copper. In addition, in response to COVID-19, the US EPA certified certain antimicrobial copper alloys as effective against SARS-COV-2. These alloys are certified to eliminate 99.9% of the virus which causes COVID-19 in under 2 hours.

Installation of the multilayer patch is quick. The multilayer patch may provide for durable use and prolonged pathogen protection but the patch need not be permanent. This provides facilities with the flexibility to either polish the patches in place or easily replace them with new patches as they wear with use.

The patches described herein hold EPA public health registrations which permit 99.9% neutralization claims against 6 of the most common microorganisms within 2 hours. Illustrative pathogens include E. coli O157:H7, a food-borne pathogen that has been associated with large-scale food recalls; Methicillin-Resistant Staphylococcus aureus (MRSA), one of the most virulent strains of antibiotic-resistant bacteria and a constant culprit to patient safety and quality in healthcare environments; Staphylococcus aureus (Staph), the most common of all bacterial staphylococcus infections that can cause life-threatening diseases, including pneumonia and meningitis; Vancomycin-Resistant Enterococcus faecalis (VRE), an antibiotic resistant organism responsible for 4% of all Healthcare-Associated Infection; Enterobacter aerogenes, a pathogenic bacterium commonly found in hospitals that causes opportunistic skin infections and impacts other body tissues; and, Pseudomonas aeruginosa, a bacterium that infects the pulmonary tracts, urinary tracts, blood, and skin of immunocompromised individuals.

The following numbered clauses include embodiments that are contemplated and non-limiting:

1. An antimicrobial composition comprising a copper material.

2. The antimicrobial composition of clause 1, wherein the composition further comprises an adhesive.

3. The antimicrobial composition of clause 2, wherein the adhesive is a self-adhesive backing.

4. The antimicrobial composition of clause 1, wherein the copper alloy is an EPA-registered antimicrobial copper material.

5. The antimicrobial composition of clause 1, wherein the copper material is a copper alloy.

6. The antimicrobial composition of clause 5, wherein the copper alloy comprises at least 40% copper.

7. The antimicrobial composition of clause 5, wherein the copper alloy comprises at least 50% copper.

8. The antimicrobial composition of clause 5, wherein the copper alloy comprises at least 60% copper.

9. The antimicrobial composition of clause 5, wherein the copper alloy comprises at least 70% copper.

10. The antimicrobial composition of clause 5, wherein the copper alloy comprises at least 80% copper.

11. The antimicrobial composition of clause 5, wherein the copper alloy comprises at least 90% copper.

12. The antimicrobial composition of clause 5, wherein the copper alloy comprises at least 99% copper.

13. The antimicrobial composition of clause 5, wherein the copper alloy comprises between about 50% to about 60% copper.

14. The antimicrobial composition of clause 5, wherein the copper alloy comprises between about 60% to about 70% copper.

15. The antimicrobial composition of clause 5, wherein the copper alloy comprises between about 70% to about 80% copper.

16. The antimicrobial composition of clause 5, wherein the copper alloy comprises between about 80% to about 90% copper.

17. The antimicrobial composition of clause 5, wherein the copper alloy comprises between about 90% to about 100% copper.

18. The antimicrobial composition of any of the above clauses, wherein the composition is adapted for use at a location selected from the group consisting of educational facilities, healthcare facilities, financial institutions, commercial real estate buildings and facilities, entertainment facilities, elevators, the hospitality industry, convenience stores, grocery stores, churches, restaurants, gym facilities, and fitness facilities.

19. The antimicrobial composition of any of the above clauses, wherein the composition is adapted for use as a consumer product.

20. The antimicrobial composition of any of the above clauses, wherein the composition is adapted for use as a retail product.

21. The antimicrobial composition of any of the above clauses, wherein the composition is adapted for use as a surface patch.

22. The antimicrobial composition of any of the above clauses, wherein the composition is adapted for use as a crash bar patch.

23. The antimicrobial composition of any of the above clauses, wherein the composition is adapted for use as a lever handle patch.

24. The antimicrobial composition of any of the above clauses, wherein the composition is adapted for use as a mobile device patch.

25. The antimicrobial composition of any of the above clauses, wherein the composition is adapted for use as a pneumatic tube carrier patch.

26. The antimicrobial composition of any of the above clauses, wherein the composition is adapted for use as a car protection patch.

27. The antimicrobial composition of any of the above clauses, wherein the composition is adapted for use as a push plate patch.

28. A method of controlling bacteria on a surface, the method comprising the step of contacting the surface with a composition of any of clauses 1-17, wherein the bacterial are controlled via contact with the composition.

### EXAMPLES

### Example 1

Table 1 contains the composite data for 216 tests that were conducted under an EPA regulation that certifies copper alloys as effective antimicrobials. The copper alloys in Table 1 are indicative of the four copper alloy groups recognized by the US EPA. The three testing protocols: efficacy as a sanitizer, residual self sanitizing, and continuous reduction, were performed to verify the antimicrobial capacity of the alloys under differing laboratory inoculation conditions.

A series of alloy comprising copper were tested against bacteria, as shown in Table 1.

TABLE 1
Average Percent Reduction of Bacterial
Contamination (Good Laboratory Practice Studies)

| | | | | S. | E. | | P. | E. coli |
|---|---|---|---|---|---|---|---|---|
| | Group | Alloy | % Cu | aureus | aerogenes | MRSA | aeruginosa | O157:H7 |
| Efficacy as | I | C110 | 99.9 | >99.9 | >99.9 | >99.9 | >99.9 | >99.9 |
| a sanitizer | II | C510 | 94.8 | >99.9 | >99.9 | >99.9 | >99.9 | >99.9 |
| | III | C706 | 88.6 | >99.9 | >99.9 | >99.9 | >99.9 | >99.9 |
| | IV | C260 | 70 | >99.9 | >99.9 | >99.9 | >99.9 | >99.9 |
| | V | C752 | 65 | >99.9 | >99.9 | >99.9 | >99.9 | >99.9 |
| | VI | C280 | 60 | >99.9 | >99.9 | >99.9 | >99.9 | >99.9 |
| Residual | I | C110 | 99.9 | >99.9 | >99.9 | >99.9 | >99.9 | >99.9 |
| Self | II | C510 | 94.8 | >99.9 | >99.9 | >99.9 | >99.9 | >99.9 |
| Sanitizing | III | C706 | 88.6 | >99.9 | >99.9 | >99.9 | >99.9 | >99.9 |
| | IV | C260 | 70 | >99.9 | >99.9 | >99.9 | >99.9 | >99.9 |
| | V | C752 | 65 | >99.9 | >99.9 | >99.9 | >99.9 | >99.9 |
| | VI | C280 | 60 | >99.9 | >99.9 | >99.9 | >99.9 | >99.9 |
| Continuous | I | C110 | 99.9 | >99.9 | >99.9 | >99.9 | >99.9 | >99.9 |
| Reduction | II | C510 | 94.8 | >99.9 | >99.9 | >99.9 | >99.9 | >99.9 |
| | III | C706 | 88.6 | >99.9 | >99.9 | >99.9 | >99.9 | >99.9 |
| | IV | C260 | 70 | 99.6 | >99.9 | >99.9 | >99.9 | >99.9 |
| | V | C752 | 65 | 99.7 | >99.9 | >99.9 | >99.9 | >99.9 |
| | VI | C280 | 60 | 99.8 | >99.9 | >99.9 | >99.9 | >99.9 |

### Example 2

Multilayer patches were applied to various high-touch points in a major US airport and microbe growth was measured. The patches were applied on Nov. 5, 2020. The surfaces were then periodically evaluated using a Luminometer ATP detection device from Nov. 9, 2020 to Dec. 9, 2020. Briefly, in this process, a sterile swab is used to collect microbial contamination from the surface in a consistent manner. The swab is then immersed in an evaluation solution and input into the Luminometer device.

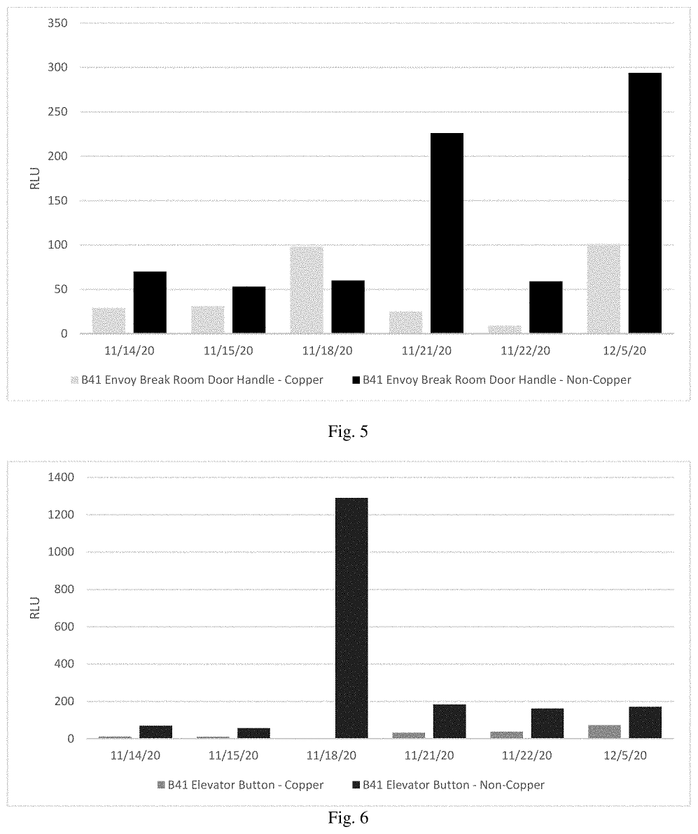

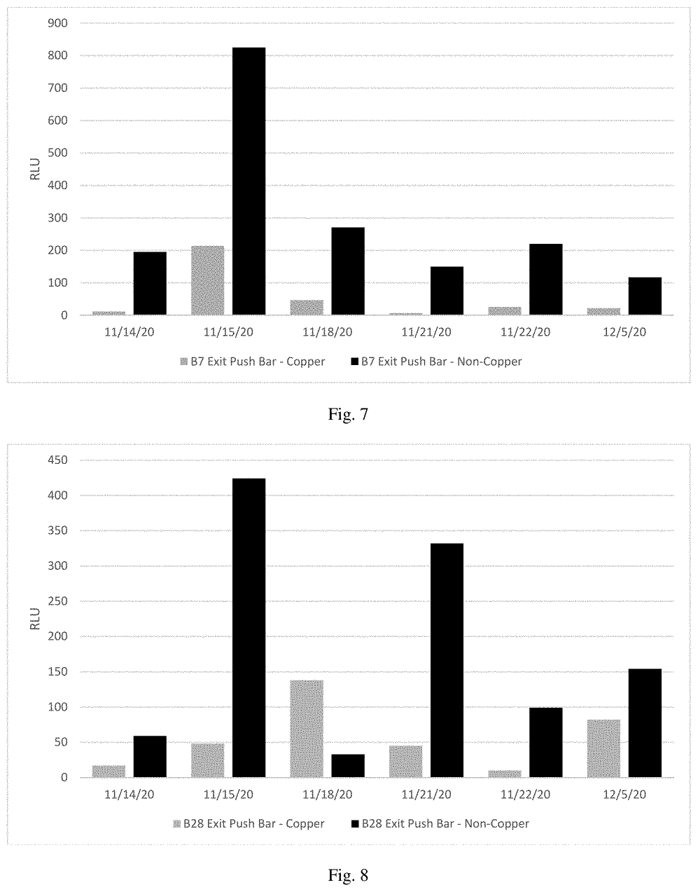

In the testing, a common industrial disinfectant, TB-Cide Quat (Spartan Chemical) was used as a control along with surfaces that were not treated with Copper Clean or disinfected. The Copper Clean surfaces consistently provided lower ATP counts than the control surfaces. Results are shown in FIGS. 4-8. FIG. 4 shows the microbe growth of a push bar without the multilayer patch compared to a push bar that had the multilayer patch. FIG. 5 shows the microbe growth of a door handle without the multilayer patch compared to a door handle that had the multilayer patch. FIG. 6 shows the microbe growth of an elevator button without the multilayer patch compared to an elevator button that had the multilayer patch. FIG. 7 shows the microbe growth of an exit push bar without the multilayer patch compared to an exit push bar that had the multilayer patch. FIG. 8 shows the microbe growth of another exit push bar without the multilayer patch compared to an exit push bar that had the multilayer patch.

1. A door handle comprising:
a body configured to receive a force from a user to open a door, and
a multilayer patch extending around at least a portion of the body, the multilayer patch arranged to be contacted by the user when the user applies a force to the body,
wherein the multilayer patch comprises an adhesive layer that is arranged to contact the body and a copper alloy layer that is arranged to be contacted by the user.

2. The door handle of claim 1, wherein the copper alloy comprises at least 70% copper.

3. The door handle of claim 1, wherein the copper alloy comprises at least 90% copper.

4. The door handle of claim 3, wherein the copper alloy comprises at least one other metal selected from the group consisting of iron, chromium zinc, nickel, cobalt, and manganese.

5. The door handle of claim 4, wherein the copper alloy comprises nickel, iron, or a combination thereof.

6. The door handle of claim 5, wherein the copper alloy comprises nickel and iron.

7. The door handle of claim 1, wherein the copper alloy comprises copper, nickel, and iron, and the copper is at least about 90% by weight of the alloy.

8. The door handle of claim 7, wherein the multilayer patch is less than about 12 mils thick.

9. The door handle of claim 7, wherein the multilayer patch is less than about 10 mils thick.

10. The door handle of claim 7, wherein the multilayer patch includes an ink layer on at least a portion of the copper alloy layer.

11. A multilayer patch comprising:
a backing layer,
an adhesive layer in direct contact with the backing layer, and
a copper alloy layer located spaced apart from the backing layer and arranged to locate the adhesive layer therebetween, the copper alloy layer comprising copper, nickel, and at least one other metal.

12. The multilayer patch of claim 11, wherein the copper alloy layer comprises iron.

13. The multilayer patch of claim 12, wherein the nickel is less than about 10% by weight.

14. The multilayer patch of claim 13, wherein the copper is at least 90% by weight of the copper alloy.

15. The multilayer patch of claim 14, wherein the multilayer patch is less than about 8 mils thick.

16. The multilayer patch of claim 14, wherein the multilayer patch has a yield strength of less than about 80 ksi.

17. The multilayer patch of claim 14, wherein the multilayer patch has a modulus of rigidity of less than about 10,000 ksi.

18. A method comprising:
peeling away a backing layer to form a multilayer patch, the multilayer patch comprising an adhesive layer and a copper alloy layer; and
coupling the multilayer patch to a surface so that the adhesive layer is located between the copper alloy layer and the surface,
wherein the multilayer patch is less than about 10 mils thick.

19. The method of claim 18, wherein the multilayer patch is coupled directly to the surface.

20. The method of claim 18, wherein the multilayer patch is coupled directly to an adaptor that is coupled to a handle.
